(19) United States
(12) Patent Application Publication
(10) Pub. No.: US 2019/0068108 A1
(43) Pub. Date: Feb. 28, 2019

(54) THERMOPHOTOVOLTAIC CONVERSION MEMBER

(71) Applicant: NIPPON STEEL & SUMITOMO METAL CORPORATION, Tokyo (JP)

(72) Inventors: Tomohiro UNO, Tokyo (JP); Shinji TOKUMARU, Tokyo (JP); Motofumi SUZUKI, Kyoto-shi (JP); Kensuke NISHIURA, Kyoto-shi (JP)

(73) Assignee: NIPPON STEEL & SUMITOMO METAL CORPORATION, Tokyo (JP)

(21) Appl. No.: 15/773,628

(22) PCT Filed: Nov. 4, 2016
(86) PCT No.: PCT/JP2016/082865

§ 371 Date: May 4, 2018

(30) Foreign Application Priority Data
Nov. 5, 2015 (JP) 2015-217650

(51) Int. Cl. H02S 10/30

(52) U.S. Cl. CPC H02S 10/30

(57) ABSTRACT

A thermophotovoltaic conversion member able to selectively absorb and emit light of a short wavelength, provided with a multilayer structure of a metal region on which at least one silicide layer and a dielectric layer are alternately formed, a total number of the silicide layers and the dielectric layers being three layers to 12 layers, the multilayer structure having, in order on the metal region 1, a silicide layer B2, a dielectric layer M3, and a silicide layer M4 and the silicide layer B2 having a thickness of 5 nm to 25 nm, the dielectric layer M3 having a thickness of 10 nm to 45 nm, and the silicide layer M4 having a thickness of 2 nm to 15 nm.

### FIELD

The present invention relates to a thermophotovoltaic conversion member selectively emitting a wavelength used in the field of energy utilization such as thermophotovoltaic power generation using the energy of exhaust heat in factories etc.

### BACKGROUND

As a method of using exhaust heat in the high temperature region of 500° C. or more, thermophotovoltaic (TPV) power generation has been the focus of attention. In thermophotovoltaic power generation, heat energy (radiated light) is converted to light having a predetermined wavelength distribution by wavelength selection at a thermophotovoltaic conversion member, the converted light is emitted from the thermophotovoltaic conversion member, then the light emitted from the thermophotovoltaic conversion member is converted to electricity by a photovoltaic (PV) cell. The TPV power generation can directly generate electric energy from heat energy, so the energy conversion efficiency is good.

Wavelength matching of the emission characteristics of the thermophotovoltaic conversion member selecting the wavelength of the radiant energy generated from a heat source and the absorption characteristics of the PV cell converting that emission to electricity becomes important. For this reason, development of a thermophotovoltaic conversion member enabling selective emission of a wavelength which a PV cell can convert to electricity has been desired.

The light which a PV cell can convert to electromotive energy is limited to a certain wavelength range. A general heat source emits various wavelengths of light in a mixed form, so even if such light strikes a PV cell, only part of the incident light can be utilized and the power generation efficiency becomes lower. In TPV power generation, if possible to convert as large as possible a part of the input energy to light of a wavelength region able to be converted by a PV cell, a high power generation efficiency could be realized. As one method of the same, utilization of a wavelength selective thermophotovoltaic conversion member would be effective.

As such a thermophotovoltaic conversion member, a photonic crystal thermophotovoltaic conversion member formed with regular relief shapes on a metal surface utilizing microprocessing technology (PLT 1), a thermophotovoltaic conversion member forming an antireflection film by a silicide film on a metal surface (PLT 2), and a thermophotovoltaic conversion member using glass in which rare earth elements absorbing near infrared light have been mixed (PLT 3) have been proposed. The fact that by forming an antireflection film by alternately stacking multiple layers of a dielectric thin film and metal thin film on a metal surface, the efficiency of emission of light of a specific wavelength is improved (PLT 4) is reported.

### CITATION LIST

### Patent Literature

### PTL 1: Japanese Patent Publication No. 2003-332607A

### PTL 2: Japanese Patent Publication No. 2011-96770A

### PTL 3: Japanese Patent Publication No. 2006-298671A

### PTL 4: Japanese Patent Publication No. 7-20301A

### SUMMARY

### Technical Problem

A general heat source emits light of various wavelengths in a mixed form, so even if such light strikes a PV cell, only part of the incident light can be utilized, the emitted heat is wasted in raising the temperature of the PV cell, and the power generation efficiency becomes lower.

The photonic crystal thermophotovoltaic conversion member described in PLT 1 is insufficient in emission characteristics. On top of that, formation of microstructures over a large area is complicated process-wise and high in manufacturing costs, so practical application has not yet been achieved. Further, in the case of the thermophotovoltaic conversion member using glass in which rare earth elements have been mixed described in PLT 3, there is the problem that the durability of rare earth elements is low and the costs high and also tuning of the wavelength is difficult.

In the past, the fact that due to formation of an antireflection film by a multilayer oxide film on the metal surface, the efficiency of emission of light of a specific wavelength is improved has been reported. However, in a material used for a usual interference filter, several dozen layers have to be stacked to lower the reflection rate. There was a problem in the point of manufacturing costs and durability.

PLT 2 proposes an antireflection film comprised of a metal on the surface of which a silicide film is formed. In the wavelength dependency of the emission rate of the antireflection film, there is a peak of the emission rate near the wavelength of 1.5 μm, but there is the problem that the suitable wavelength range is narrow. If off from this range, the emission rate rapidly falls, so the power generation efficiency was not sufficient.

If increasing the absorption of light, the emission rate also becomes larger. According to Kirchhoff's law, the absorption rate and emission rate are equal at a certain wavelength. Therefore, they can be represented by the emission rate. Absorption and emission are equal in effect in a wavelength selective thermophotovoltaic conversion member, so in the Description, the two will be explained represented by the emission rate unless particularly necessary.

As typical PV cells, GaSb, InGaAsSb, etc. are promising. The wavelengths of the wavelength regions with high emission rates in these elements are 0.8 to 1.8 μm and 1 to 3 μm in range. These correspond to the near infrared region. To efficiently generate power using these PV cells, it is important to raise the heat emission at a wavelength range of a wavelength of 0.5 to 3 μm to raise the power generation efficiency. Simultaneously, it is desirable to keep low the heat emission in the range of a wavelength of 3 to 5 μm, longer than the above range, so as to keep down the rise in temperature of the cell.

In a conventional thermophotovoltaic power generation-use thermophotovoltaic conversion member, many points for improvement remain such as the insufficient wavelength selectivity, the insufficient durability in an actual environment due to low high temperature durability, the manufacturing costs, and the low mass producibility. Up to now, it has not been possible to use this for a method of power generation utilizing solar heat or factory exhaust heat.

The present invention has as its object the provision of a thermophotovoltaic conversion member enabling selective absorption and emission of short wavelength light.

### Solution to Problem

The thermophotovoltaic conversion member according to the present invention is comprised of a multilayer structure comprised of a metal region on which at least one silicide layer and dielectric layer are alternately formed, a total number of the silicide layers and the dielectric layers being three layers to 12 layers, the multilayer structure having, in order on the metal region, a silicide layer B positioned most at the metal region side among the silicide layers, a dielectric layer M among the dielectric layers, and a silicide layer M other than the silicide layer B among the silicide layers and the silicide layer B having a thickness of 5 nm to 25 nm, the dielectric layer M having a thickness of 10 nm to 45 nm, and the silicide layer M having a thickness of 2 nm to 15 nm.

### Advantageous Effects of Invention

According to the present invention, due to the composite effect of utilizing the interference phenomenon and reflection phenomenon of light, the effect is obtained of continuously raising the emission rate (=absorption rate) in the sensitivity region of a PV cell of a wavelength range of 0.5 to 2.0 μm by a high value.

### BRIEF DESCRIPTION OF DRAWINGS

FIGS. 1A to 1C are vertical cross-sectional views showing the configurations of multilayer structures according to the present embodiment, wherein FIG. 1A shows a three-layer structure, FIG. 1B shows a four-layer structure, and FIG. 1C shows a six-layer structure.

FIG. 2 is a vertical cross-sectional view showing the configuration of a multilayer structure provided with a dielectric layer B according to the present embodiment.

FIG. 3 is a graph showing an example of the characteristics of a thermophotovoltaic conversion member according to the present embodiment.

### DESCRIPTION OF EMBODIMENTS

Below, referring to the drawings, embodiments of the present invention will be explained in detail.

In the thermophotovoltaic conversion member of the present embodiment for solving the above problem, it was discovered that providing a multilayer structure comprised of a metal region on which at least one silicide layer and dielectric layer are alternately stacked is effective for wavelength selectivity and mass producibility. The “metal region” in the present embodiment means a film or bulk made of a metal. Heat energy (emitted light) emitted from a heat source enters from the metal region side or substrate side below the metal region where the wavelength is selected by the thermophotovoltaic conversion member and is emitted from the surface of the multilayer structure of the silicide layers and dielectric layers.

In the present embodiment, to raise the power generation efficiency of a PV cell, the wavelength range raising the emission rate is made 0.5 to 2.0 μm. Here, the reason for selecting the wavelength range of 0.5 to 2.0 μm is that this is an effective and important wavelength range where the power generation efficiency of the PV cell is high and verification by experiments is relatively easy. Below, the 0.5 to 2.0 μm wavelength range will be called the “sensitivity region”, while a wavelength side longer than that, the 3 to 5 μm wavelength range, will be called the “long wavelength region”. Further, due to the present embodiment of the multilayer structure, raising the emission rate (absorption rate) of the sensitivity region to reduce the emission rate (absorption rate) of the long wavelength region improves the wavelength selectivity. In this Description, the “wavelength selectivity” is defined as the ratio (S/L) of the emission rate (S) at the sensitivity region of the wavelength of 0.5 to 2.0 μm to the emission rate (L) at the long wavelength region of the wavelength of 3 to 5 μm.

In the multilayer structure, a silicide layer is labeled as the “silicide layer B” when positioned the bottommost at the metal region side and as a “silicide layer M” otherwise, while a dielectric layer is labeled as the “dielectric layer B” when positioned between the metal region and silicide B and having a thickness of 5 nm to 25 nm, as the “dielectric layer T” when positioned at the surfacemost side (top side in figure) and having a thickness of 80 nm to 200 nm, and as a “dielectric layer M” for a dielectric layer other than the dielectric layer B and dielectric layer T which has a thickness of 10 nm to 45 nm. Note that, in the multilayer structure, sometimes there are two or more dielectric layers M present. Further, in the multilayer structure, sometimes there are two or more silicide layers M present.

The multilayer structure is comprised of a metal region on which at least one silicide layer and dielectric layer are alternately formed, a total number of the silicide layers and the dielectric layers being three layers to 12 layers, having, in order on the metal region, a silicide layer B positioned most at the metal region side among the silicide layers, a dielectric layer M among the dielectric layers, and a silicide layer M other than the silicide layer B among the silicide layers and the silicide layer B having a thickness of 5 nm to 25 nm, the dielectric layer M having a thickness of 10 nm to 45 nm, and the silicide layer M having a thickness of 2 nm to 15 nm.

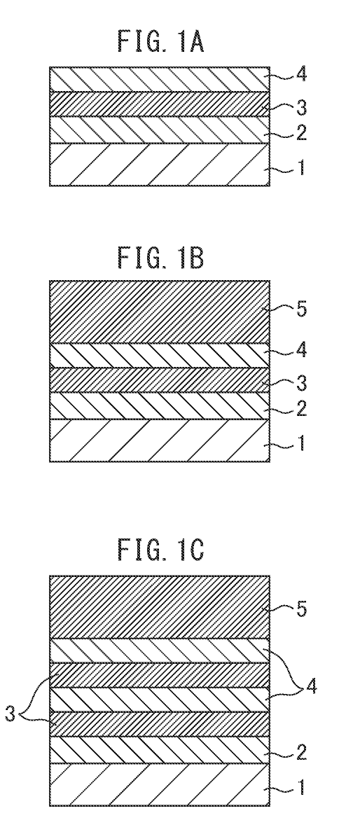

A thermophotovoltaic conversion member provided with such a multilayer structure gives the effect of continuously raising the emission rate (=absorption rate) at a high value in the sensitivity region of a PV cell of a wavelength range of 0.5 to 2.0 μm due to the composite effect utilizing the interference phenomenon and reflection phenomenon of light. The multilayer structure enables a high value of an emission rate at room temperature of 0.9 or more to be achieved. By using a thermophotovoltaic conversion member able to obtain such a high emission performance, it is possible to raise the electromotive force of the PV cell and possible to improve the energy conversion efficiency to a practical level. The three-layer structure forming the basis of the multilayer structure, as shown in FIG. 1A, is a (metal region 1/)silicide layer B2/dielectric layer M3/silicide layer M4 configuration. By increasing the layers of the stacked silicide layer/dielectric layer, a higher effect is obtained by effectively utilizing the interference phenomenon of light. In the notation of the multilayer structure in this Description, the left side of the symbol of “/” means a lower layer, while the right side means an upper layer. In this Description, the number of layers of the multilayer structure indicates the total of the number of the silicide layers and dielectric layers. The metal region is not included.

The state of a continuously high emission rate in the above-mentioned wavelength range of 0.5 to 2.0 μm means that in the above wavelength range, the value is a high one with no region where the emission rate greatly fluctuates up and down. Below, such behavior will be called “wavelength stability of emission”. With just the characteristics at the conventional specific wavelength, it is difficult to judge the effective efficiency, but quantitatively judging the emissivity or endothermy by the wavelength stability is effective for evaluating the true power generation efficiency.

The thermophotovoltaic conversion member preferably has a total of the silicide layers and dielectric layers of four layers to 12 layers and has a thickness of the dielectric layer T formed at the surfacemost side of 80 nm to 200 nm. That is, the basic four-layer structure is configured by, in order on the metal region, a silicide layer B, dielectric layer M, silicide layer M, and dielectric layer T. The thickness of the silicide layer B is 5 nm to 25 nm, the thickness of the dielectric layer M is 10 nm to 45 nm, the thickness of the silicide layer M is 2 nm to 15 nm, and the thickness of the dielectric layer T is 80 nm to 200 nm. The thermophotovoltaic conversion member having such a four-layer structure improves the emissivity at ordinary temperature in the sensitivity region of the wavelength of 0.5 to 2.0 μm and keeps low the emissivity of the long wavelength region of the wavelength of 3 to 5 μm to be able to further improve the wavelength selectivity. For example, there is the excellent effect that the thermophotovoltaic conversion member maintains an emission rate of a high value of 0.9 or more in a wavelength range of 70% or more of the sensitivity region. Further, it is possible to keep the emission rate of the long wavelength region down to 0.2 or less and possible to improve the wavelength selectivity ratio to 0.8 or more.

The dielectric layer T formed at the above surfacemost side has a thickness of 80 nm to 200 nm in the basic configuration of the multilayer structure illustrated as a four-layer structure of a (metal region 1/)silicide layer B2/dielectric layer M3/silicide layer M4/dielectric layer T5 configuration (FIG. 1B) or a five-layer structure of a (metal region/)silicide layer B/dielectric layer M/silicide layer M/dielectric layer T/silicide layer M configuration (not shown), a six-layer structure of a (metal region 1/)silicide layer B2/dielectric layer M3/silicide layer M4/dielectric layer M3/silicide layer M4/dielectric layer T5 configuration (FIG. 1C), etc.

The roles of the silicide layers, dielectric layers, and metal region forming the multilayer structure are not to exhibit effects as single layers. They can exhibit effects of improving the wavelength selectivity overall by the synergistic action by the combination of the plurality of layers, the balance of thicknesses of several layers, etc. The actions of these layers will be explained.

The thickness of the silicide layer B formed at a position near the metal region side in the multilayer structure is 5 nm to 25 nm. Further, the thickness of the dielectric layer T formed at the surfacemost side is 80 nm to 200 nm. Due to this, it is possible to achieve both the action of improving the emission rate at 1 to 2.0 μm at the long wavelength side in the sensitivity region and the action of keeping low the emission rate at the long wavelength region of the wavelength of 3 to 5 μm. That is, a high effect of improvement of the wavelength selectivity is obtained. If the thickness of the silicide layer B is less than 5 nm, the emission rate falls. If over 25 nm, the emission peak moves to the long wavelength side whereby the emission rate at less than a wavelength of 2.0 μm falls. If the thickness of the dielectric layer T is less than 80 nm, the emission rate at the wavelength of 1 to 2.0 μm falls, while if over 200 nm, the emission rate at the sensitivity region of less than the wavelength of 2.0 μm falls overall.

The thickness of a dielectric layer M placed in the middle of the multilayer structure is 10 nm to 45 nm while the thickness of a silicide layer M is 2 nm to 15 nm. Due to this, the high effect is exhibited that the emission rate in the range of 0.5 to 1.3 μm of the low wavelength side of the sensitivity region is improved and the overall wavelength stability of the sensitivity region is improved. If the thickness of the dielectric layer M is less than 10 nm, the above effect is small, while if over 45 nm, the emission rate in the sensitivity region ends up fluctuating. If the silicide layer M is less than 2 nm, the above effect is small while if over 15 nm, the emission rate at the long wavelength region ends up increasing.

Due to the configuration of the metal region/silicide layer B having or contacting the silicide layer B on the metal region, the effect of raising the emission rate to 0.9 or more in the wavelength range of 1 to 1.5 μm even in the sensitivity region is obtained. By utilizing the reflection at the metal region/silicide layer B interface and the interference action by the 2 nm to 15 nm silicide layer M, the emission rate can be raised to a high value of 0.9 or more. The effect of raising the emission rate is effective at a heating temperature up to 700° C. or so. The corresponding multilayer structure is illustrated as a three-layer structure of a (metal region 1/)silicide layer B2/dielectric layer M3/silicide layer M4 configuration (FIG. 1A), a four-layer structure of a (metal region 1/)silicide layer B2/dielectric layer M3/silicide layer M4/dielectric layer T5 configuration (FIG. 1B), etc.

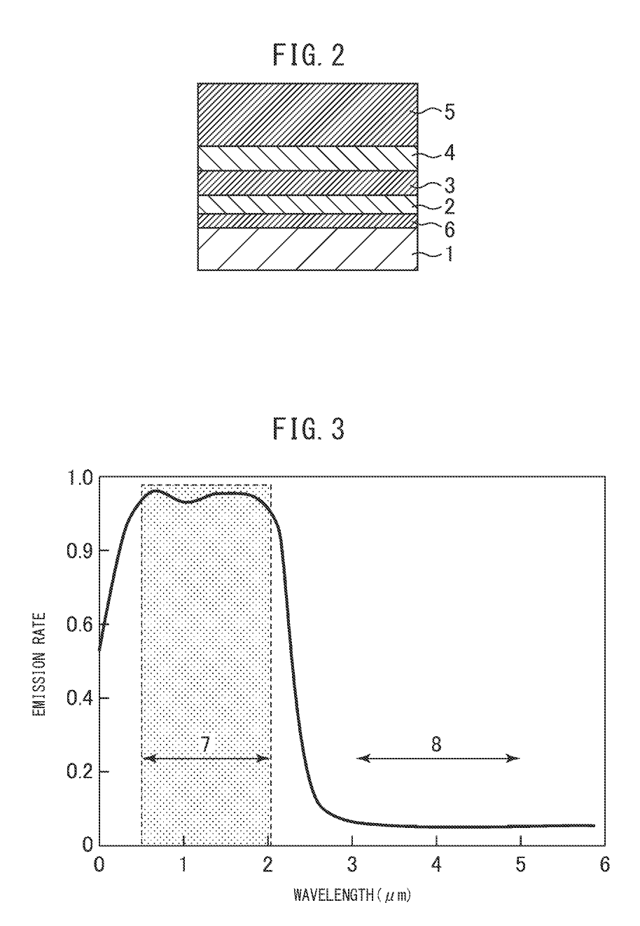

In a configuration including a metal region/dielectric layer B/silicide layer B comprising a dielectric layer B formed between a metal region and a silicide layer B, by forming the thickness of the dielectric layer B to 5 nm to 25 nm, even after high temperature heating, deterioration of the interface state is suppressed and the effect of maintaining the emission rate is increased. The dielectric layer B plays the role of a barrier suppressing diffusion of the metal region and silicide layer B to thereby obtain an effect of improvement stable even at a high temperature. The dielectric layer B is useful if deterioration of the emission characteristic due to diffusion at the interface of the metal region/silicide layer B is a concern if heated to a high temperature over 800° C. Regarding the thickness of the dielectric layer B, if less than 5 nm, the effect of suppressing diffusion at a high temperature over a long period of time is small, while if over 25 nm, a drop in the emission rate at ordinary temperature in the 1 to 1.5 μm wavelength range is feared. The corresponding multilayer structure is illustrated as a four-layer structure of a (metal region/)dielectric layer B/silicide layer B/dielectric layer M/silicide layer M configuration (not shown), a five-layer structure of a (metal region 1/)dielectric layer B6/silicide layer B2/dielectric layer M3/silicide layer M4/dielectric layer T5 configuration, etc. (FIG. 2).

The multilayer structure of the present embodiment gives the high effect of increasing the high temperature emission rate due to the thickness of the silicide layer B being 60% or less of the thickness of the dielectric layer M contacting the silicide layer B from above. By forming a sandwich type of configuration of a (metal region/)silicide layer B/dielectric layer M, the effect of raising the high temperature emission rate is increased by the synergistic action of emission from the metal region and the interference by the silicide layer B and dielectric layer M.

In the multilayer structure of the present embodiment, the thickness of the dielectric layer T is 8 times or more of the thickness of the silicide layer M contacting the dielectric layer T from below, whereby the effect of utilizing interference between layers to improve the wavelength stability and raise the emission rate increases. In the multilayer structure, by being made multilayer by such a relationship of thicknesses, the wavelength region in the sensitivity region where the emission rate falls is made narrower and the wavelength selectivity is improved.

In the multilayer structure, by making the total of the number of silicide layers and dielectric layers of four layers to 12 layers, the effect is obtained of raising the ordinary temperature and high temperature emission rates. The multilayer structure has two or more sets of dielectric layers and silicide layers, so multilayer interference can be utilized. If the number of layers exceeds 12 layers, problems arise such as a drop in the productivity, a rise in the manufacturing costs, and greater complication of quality control. The more preferable total of the layers is four layers to eight layers. If so, the ordinary temperature emission rate can be raised more. The metal region can raise the reflectance by a single region. As a result, the function of improvement of wavelength selectivity is obtained, but a structure comprised of a plurality of metal regions stacked together is also possible.

In the multilayer structure, by forming a silicide layer on the metal region, it is possible to utilize the reflection at the interface of the metal region/silicide layer B to easily raise the emission rate at ordinary temperature. As the corresponding multilayer structure, a three-layer structure of a (metal region 1/)silicide layer B2/dielectric layer M3/silicide layer M4 configuration (FIG. 1A), a four-layer structure of a (metal region 1/)silicide layer B2/dielectric layer M3/silicide layer M4/dielectric layer T5 configuration (FIG. 1B), etc. may be illustrated.

In the multilayer structure, by forming a dielectric layer B on the metal region, it is possible to suppress diffusion at the interface of the metal region/dielectric layer B at the time of high temperature heating and possible to raise the high temperature emission rate. In particular, the emission characteristic at an ultrahigh temperature over 500° C. can be stabilized.

FIG. 3 is a graph showing an example of the characteristics of the thermophotovoltaic conversion member of the present embodiment. The ordinate shows the emission rate, while the abscissa shows the wavelength (μm). From the figure, it will be understood that the emission rate changes according to the wavelength. In the sensitivity region 7 of the range of wavelength of 0.5 to 2.0 μm, the emission rate is high, while in the long wavelength region 8 of a range of wavelength of 3 to 5 μm longer than that, the emission rate is kept low.

To improve the effect of raising the wavelength selectivity, the ratio of the refractive index of the material of the dielectric layer with respect to the refractive index of the material of the silicide layer is preferably 60% or less. By the ratio of the refractive index being 60% or less, the interference of light near the interface of the dielectric layer and the refractive index is raised and the wavelength selectivity is raised. More preferably, by making it 50% or less, a greater effect in raising the wavelength selectivity is obtained. This is believed to be because of utilization of the multilayer interference of light by the silicide layer and dielectric layer.

Further, due to the surface of the multilayer structure being a dielectric layer or due to the thicknesses and number of the silicide layers and dielectric layers being suitably set, the power generation efficiency can be raised. As materials useful for the multilayer structure, for the silicide layers, β-FeSi₂ and CrSi₂ can be used. Further, for the dielectric layers, for example, SiO₂, alumina, etc. can be used. Due to this, a higher effect of raising the high temperature emission rate is obtained.

If utilizing such a thermophotovoltaic conversion member having a multilayer structure excellent in wavelength selectivity for photovoltaic conversion, there are high characteristics only near the sensitivity region of the PV cell, so high emissivity is confirmed. For example, by simultaneously using the GaSb of the PV cell and the thermophotovoltaic conversion member, it is possible to keep down the rise in temperature while raising the electromotive force. That is, a thermophotovoltaic conversion member having this multilayer structure has the effect of raising the power generation efficiency of the photovoltaic conversion.

The silicide layers are often comprised of single types of films, but may also be formed by two or more types of silicide layers adjoining each other. In this case, one set of adjoining silicide layers is deemed as a single silicide layer. Similarly, the dielectric layers are also often comprised of single types of films, but may also be formed by two or more types of dielectric layers adjoining each other. In this case as well, they are deemed as a single dielectric layer. This is because adjoining similar types of layers have the common action of raising the emissivity.

The layers of the present embodiment are preferably continuously covered, but some may have defects and local uncovered regions may also be included. The ratio of these defects and uncovered regions is preferably less than 10 vol % of the layers.

If even one of the silicide layers, dielectric layers, and metal region is missing, a wavelength region where the emission rate falls in the above wavelength range ends up occurring. For example, with just a silicide layer and metal region, the emission rate in the short wavelength range of 0.5 to 1.2 μm is low. With just a silicide layer and dielectric layer, the emission rate falls in the wavelength range of 1.2 to 2.0 μm. As a result, the power generation efficiency of the PV cell is lowered.

The layer arranged on the metal region is preferably a silicide layer. That is, by configuring the structure by a metal region/silicide layer/dielectric layer, the effect of emission is higher than a configuration of a metal region/dielectric layer/silicide layer. This is believed to be because a silicide layer arranged on a metal region increases the effect of reflection of the metal region and results in a higher effect of absorption of the reflected light.

Since the multilayer structure has a dielectric layer at the surface, the wavelength selectivity can be improved by raising the emission rate of light in the sensitivity region of the range of the wavelength 0.5 to 2.0 μm and keeping it down in the long wavelength region of 3 μm or more. Due to the multilayer structure having a dielectric layer at the surface, it is believed that light entering from the surface first passes through the interface formed by arrangement of the silicide layer/dielectric layer and the interference of light is effectively utilized to raise the effect of absorption of heat. As the corresponding multilayer structure, a four-layer structure of a (metal region 1/)silicide layer B2/dielectric layer M3/silicide layer M4/dielectric layer T5 configuration (FIG. 1B) may be illustrated.

Due to the four-layer multilayer structure, the effect is obtained of further raising the wavelength selectivity of emission, and high performance can be realized by a low manufacturing cost and mass production. If four layers, high quality control becomes possible even over a large area. It was confirmed that compared with a comparative material from which the dielectric layer was removed from the surface, that is, a three-layer structure of a metal region/silicide layer/dielectric layer/silicide layer configuration, the above four-layer structure can increase the emission rate (=absorption rate) in the 0.5 to 2.0 μm wavelength range by an average 10 to 30% and, in a range over a wavelength 3 μm, can keep the emission rate further lower than a three-layer structure.

If the number of layers in a group of dielectric layers or silicide layers is two layers or more, since each group is comprised of layers of the same compositions and structures, there are many advantages such as ease of control of performance and production. On the other hand, the layers of the dielectric layers and the layers of the silicide layers may also be formed by different compositions and structures. The emissivity, heat resistance, and other functionality can also be improved.

A structure where a dielectric layer is formed on the surface, the structure is comprised of four or more layers, and the dielectric film is the thickest at the surface among the dielectric layers forming the structure is preferable. By arranging the thickest dielectric layer at the surface, it is possible to stably and continuously raise the emission rate in the range of the wavelength of 0.5 to 2.0 μm and improve the wavelength stability. In experiments, it was confirmed that the emission rate could be improved to a high level of 0.9 to 0.98.

The refractive index of the silicide layers is preferably a high value of 4.2 or more. Due to this, it is possible to raise the emission rate and absorption rate due to interference of the silicide layer and dielectric layers. Further, in addition to vertical incidence, light incident from a slanted direction is also refracted raising the emission rate.

The silicide layers are preferably mainly comprised of one compound selected from β-FeSi₂ and CrSi₂. “Mainly comprised” means having a concentration of over 50 mol %. β-FeSi₂ and CrSi₂ have considerably high values of refractive indexes of 5 or more, so it is possible to increase the difference in refractive indexes of the silicide layers and dielectric layers and raise the absorption rate. Furthermore, β-FeSi₂ and CrSi₂ are high in heat resistance, so do not deteriorate even if exposed to a high temperature of about 500° C. in the atmosphere at the time of use and are excellent in high temperature storability. Furthermore β-FeSi₂ is more preferable as a multilayer structure silicide layer. β-FeSi₂ is excellent in high refractive index, heat resistance, etc. Since it is comprised of Fe(iron) and Si(silicon), it is excellent in terms of manufacturing costs and in terms of safety.

The refractive index of the dielectric layers is preferably 2.5 or less. Due to the refractive index being 2.5 or less, the effect of utilizing the interference of the dielectric layers and increasing the emission rate overall is obtained.

Due to the synergistic action of the refractive index of the silicide layers being 4.2 or more and the refractive index of the dielectric layers being 2.5 or less, the difference in refractive index becomes larger so the effect of absorption due to the multilayer interference of the silicide layers and dielectric layers, that is, improvement of the emission rate, can be raised.

The dielectric layers are preferably mainly comprised of SiO₂ or Al₂O₃. The advantages of SiO₂ and Al₂O₃ are an improved emission rate since the refractive indexes are low, that is, 1.5 and 1.76 and are a high heat resistance, so excellent high temperature storability. Furthermore, by combining SiO₂ and β-FeSi₂ to form the multilayer structure, the effect is obtained that the efficiency of conversion of emitted light striking it from various angles is improved and the amount of power generation is increased. This utilizes the refraction phenomenon at the interface of the SiO₂ and β-FeSi₂ to obtain an elevated high temperature storability. In addition, the effect of the incident angle is reduced and hemispherical light can be efficiently utilized so the power generation efficiency can be raised.

The metal region is mainly comprised of a pure metal selected from one of W, Mo, Fe, Ni, Cr, Au, and Ag or an alloy of the same. Due to this, both a high effect of increasing the emission rate and heat resistance in a 500° C. or so high temperature environment can be realized. These metals can increase the reflectance at the wavelength region of infrared rays, so promote the interference of light of the dielectric layers and silicide layers resulting in a higher effect of raising the emission or absorption of light. The metals can be selected in accordance with the performance in use demanded from the thermophotovoltaic conversion member or practical application. The reflectance changes depending on the type of the metal, so it is possible to obtain the desired emission rate or absorption rate by adjusting the types, thicknesses, etc. of the dielectric layers and silicide layers. If the metal region is a pure metal, it is easy to raise the reflectance, while if an alloy, the strength, heat resistance, etc. can be improved. If an Fe alloy of stainless steel (SUS), there is the advantage that oxidation resistance enables stable use.

Among these, if W, Mo, or Fe, a high effect of suppressing deterioration of the performance even in a high temperature environment of up to 700° C. can be obtained. These metal regions are advantageous for applications involving exposure to a high temperature environment such as recovery of factory waste heat. Fe is high in strength and inexpensive, so is advantageous for increasing size. Ni and Cr have the advantages of being relatively inexpensive and chemically stable. If Au and Ag, the reflectance is further higher, so the wavelength selectivity can be improved.

The thickness of the metal region forming the multilayer structure is preferably 20 nm or more. If the metal region has a thickness of 20 nm or more, a sufficient effect of raising the emission and absorption can be obtained by raising the reflectance. Preferably, if 40 nm or more, the effect is obtained of raising and supporting the strength.

For the support material forming the metal region, a metal bulk or sheet or a silicon, glass, or other base material can be used. If the support material is a metal bulk or sheet, the adhesion with the metal region is good and the difference in thermal expansion is also small, so the reliability is good. Further, silicon, glass, and other base materials are excellent in flatness of the surface, so it is possible to improve the flatness of the multilayer film formed on the same overall. As a result, by stabilizing the interference at the interfaces of the films, good reflectivity is obtained.

The thermophotovoltaic conversion member having the multilayer structure of the present embodiment is formed with a substrate below the metal region. The substrate is configured by silicon or a metal. An SiC layer is formed on the surface side of the substrate (opposite side to metal region). This thermophotovoltaic conversion member can be used for a thermophotovoltaic power generation-use thermophotovoltaic conversion member. The thermophotovoltaic power generation-use thermophotovoltaic conversion member is useful for TPV power generation. The SiC layer formed on the surface side of the substrate functions as a blackbody with a high absorption rate. By emitting the incident heat, the high effect is obtained of raising the emission function at a high temperature of 550° C. or more. The thermophotovoltaic power generation-use thermophotovoltaic conversion member on which the SiC layer is formed was confirmed to be raised in emissivity as a high temperature thermophotovoltaic conversion member by 10 to 30% compared with the case where an SiC layer is not formed. For formation of the SiC film, the CVD method (chemical vapor deposition), high frequency sputtering method, carburization method, etc. may be used. With the CVD method, carbon-containing gas and silicon-containing gas can be thermally broken down and made to react on the substrate to thereby deposit an SiC film on the substrate. An SiC film can be made to deposit on an Mo or W or other metal substrate by the high frequency sputtering method. Further, by the latter carburization, the SiC film can be formed by carburization of the Si substrate surface by a hydrocarbon gas.

By using silicon or metal for the substrate, heat from the SiC layer is efficiently conveyed to the thermophotovoltaic conversion member and a sufficient strength is obtained. Preferably, by using silicon, the flatness obtained by suppression of relief shapes on the surface is excellent, so the flatness of the metal region and multilayer structure formed on it can be raised. As a result, the reflectance and the wavelength selectivity are improved. The silicon may be either polycrystal or single crystal. If a metal, Fe, Cu, and alloys of the same and stainless steel etc. are preferable.

The substrate is comprised of at least one of Fe, an Fe alloy, and an Ni alloy. Due to the thermophotovoltaic power generation-use thermophotovoltaic conversion member formed with an oxide layer on the surface side of the substrate, it is possible to raise the emission rate of the thermophotovoltaic conversion member. As the Fe alloy, SUS304 is preferably illustrated, while as the Ni alloy, Inconel is preferably illustrated. The iron oxide layer formed on the surface side of the substrate is high in absorption rate, the heat incident from the surface can be efficiently conducted to the substrate and thermophotovoltaic conversion member, and as a result it is possible to contribute to the rise in emissivity at a 550° C. or more high temperature. Compared with the case where an oxide layer is not formed, it was confirmed that the emissivity of the thermophotovoltaic power generation-use thermophotovoltaic conversion member is raised by about 10 to 20%. When using Fe or SUS for the substrate, it is possible to heat the substrate to easily form the oxide layer on the surface. The adhesion with the oxide layer is also excellent.

When evaluating or using a thermophotovoltaic conversion member or thermophotovoltaic power generation-use thermophotovoltaic conversion member, two directions are possible for the direction in which the light or infrared rays are fired: the case of firing them from the metal region side and the case of firing them from the multilayer structure side. By mainly firing them from the side of the metal region formed on the substrate, it is possible to fire infrared rays radiated from factory exhaust heat or other high temperature heat sources from the metal region side and emit the wavelength selected light from the multilayer structure.

As the method of forming the silicide layers, the sputtering method, MBE (molecular beam epitaxy) method, CVD method, laser ablation method, and other film-forming methods can be used. Among these as well, to form a large area wavelength selective film, a sputtering method with which a film can be easily formed with a high reproducibility even over a large area is preferable. The methods for forming FeSi₂ by the sputtering method are illustrated below. It is possible to use a target of a molar ratio composition of Fe:Si=1:2 and heat the target of film formation to 400 to 700° C. to produce the targeted β-FeSi₂ type crystal structure. By X-ray diffraction, the structure can be confirmed to be a β-FeSi₂ type. When the concentration of Si decreases from the target composition in the film formed at a high temperature, the technique of using a target raised in composition of Si to 70 to 80% or so or the technique of easily adjusting the composition by placing a small piece of Si on the target can be used to make the molar ratio composition of the thin film approach Fe:Si=1:2. By setting a suitable film forming temperature, pressure, or other sputtering conditions, it is possible to form a thin film with a crystal structure of β-FeSi₂. The silicide layer may be either a single crystal or polycrystal.

Regarding the method of forming the dielectric layers, the vacuum deposition method, the sputtering method, and the CVD method can be used. With any of the methods, it is easy to control the dielectric SiO₂ and Al₂O₃ layers to thicknesses of tens of nm and possible to raise the uniformity. Furthermore, the vacuum deposition method and the sputtering method are advantageous for increasing areas and are excellent in productivity.

For the method of forming the metal region, the vacuum deposition method and the sputtering method can be used. With either of the methods, it is possible to form the W, Mo, Fe, Ni, Cr, or other metal region thinly and uniformly and possible to form a film with a good flatness. As the method for continuously forming all of the silicide layers, dielectric layers, and metal region, the sputtering method is preferable. According to the sputtering method, it is possible to continuously form the multilayer structure within a chamber by changing the target among a plurality of targets prepared in advance, so productivity is excellent. As one example of continuous film formation by the sputtering method, three types of targets of Mo, SiO₂, and FeSi₂ were used to continuously and stably form an Mo region, β-FeSi₂ layer, SiO₂ layer, β-FeSi₂, and SiO₂ layer on the base material in that order. The base material has to be flat at its surface and satisfy the heat resistance and environmental resistance at the time of use as a thermophotovoltaic power generation-use thermophotovoltaic conversion member. Si, SiC, etc. are desirable, but the invention is not limited to these.

The prepared thermophotovoltaic conversion members could be confirmed as having predetermined thicknesses controllable within a range of variation of several nm, being good in flatness, and having high emission characteristics.

The emission rate at a high temperature is measured using an apparatus able to separate light emitted from a blackbody furnace and light emitted from a sample heated in the sample heating furnace by a visible to infrared light spectrometer through a light guide. First, the light emitted from a blackbody furnace heated to a predetermined temperature (emission rate 1) is measured, the spectrometer is corrected, then the sample heated to the same set temperature as the blackbody furnace by the sample heating furnace is measured. Furthermore, the true temperature of the heating furnace is found by coating the surface of the same sample with a blackbody spray with a known emission rate and heating it by the set temperature for measurement. The ratio of the intensity of the light emitted from the sample to the intensity of light of the emission rate 1 of each wavelength at the true temperature is defined as the emission rate. Further, when the set temperature is 500° C., the true temperature is 500±10° C.

Further, the emission rate at ordinary temperature is found by measuring the reflectance using only a visible to infrared light spectroscope since if the energy reflectance in the case of vertical incidence is R, the emission rate (=absorption rate) is 1-R.

The thermophotovoltaic conversion member according to the present invention has excellent characteristics. The thermophotovoltaic conversion member according to the present invention is excellent in wavelength dependency of the emission rate at ordinary temperature (25±10° C.). In particular, the average value of the ordinary temperature emission rate in the range of the wavelength 0.5 to 2.0 μm is 0.7 or more, preferably 0.8 or more, more preferably 0.9 or more. Further, the thermophotovoltaic conversion member according to the present invention is excellent in wavelength dependency of the emission rate at high temperatures of 500° C. and 600° C. In particular, the average value of the high temperature emission rate in the range of the wavelength of 0.5 to 2.0 μm is 0.6 or more, preferably 0.7 or more, more preferably 0.85 or more. Further, the thermophotovoltaic conversion member according to the present invention is excellent in wavelength selectivity. In particular, the ratio of the ordinary temperature emission rate at the sensitivity region of the wavelength of 0.5 to 2.0 μm to the ordinary temperature emission rate at the long wavelength region of the wavelength of 3 to 5 μm is 2 or more, preferably 3 or more, more preferably 4 or more. Further, the thermophotovoltaic conversion member according to the present invention is excellent in wavelength stability. In particular, in the short wavelength range of the wavelength of 0.5 to 2.0 μm (however, the region where the emission rate falls at the two ends excluded from coverage), the rate of drop of the emission rate of the lowest value (M) with respect to the highest value (M) of the emission rate is 0.5 or more, preferably 0.7 or more, more preferably 0.8 or more. Further, the thermophotovoltaic conversion member according to the present invention is excellent in high temperature storability. In particular, the change of the average value of the ordinary temperature emission rate in the range of wavelength of 0.5 to 2.0 μm after high temperature heating of a sample in the atmosphere at 700° C. for 200 hours (ratio of ordinary temperature emission rate after high temperature heating with respect to ordinary temperature emission rate before heating) is 0.5 or more, preferably 0.7 or more, more preferably 0.9 or more.

### Example 1

On a substrate, by the sputtering method, a metal region, silicide layer, and dielectric layer were consecutively formed by changing the target. Regarding the specific material, in the metal region, W, Mo, Fe, Ni, Cr, Au, Ag, and SUS were used, at the silicide layer, β-FeSi₂ and CrSi₂ were used, and at the dielectric layer, SiO₂ and Al₂O₃ were used.

Quartz glass was used as a substrate and the substrate temperature was set to 600° C. or room temperature. The sputtering was performed in an Ar atmosphere (flow rate 20 sccm, pressure 0.4 Pa). For the target, β-FeSi₂, CrSi₂, metal target, etc. was used. Further, a DC power supply was used to generate plasma by a sputter power of 50 W. The thicknesses of samples formed by sputtering by various materials alone in advance were measured by a stylus profilometer, the film-forming speeds were found, and the sputter times were controlled to give the predetermined thicknesses. Using X-ray diffraction, it was confirmed that the layers were β-FeSi₂ and CrSi₂.

For preparation of a silicon substrate formed with an SiC film on its surface, one obtained using the CVD method to form SiC to a range of thickness of 5 to 30 μm on the surface of an Si substrate was prepared. Further, for substrates of carbon steel and stainless steel formed on their surfaces with films of iron oxide to thicknesses of 1 to 20 μm, ones formed by 1200° C. or more high temperature heating were prepared.

For measurement of the ordinary temperature emission rate, the total reflectance Ra was measured for vertically striking light (incident angle 10 degrees) by a reflection spectrometer and the emission rate (=absorption rate) was found by 1-Ra.

The emission rate at a high temperature is measured using an apparatus able to separate light emitted from a blackbody furnace heated to 500 to 600° C. and light emitted from a sample heated in the sample heating furnace by a visible to infrared light spectrometer through a light guide. First, the light emitted from the blackbody furnace heated to 500° C. (emission rate 1) is measured, the spectrometer is corrected, then the sample heated to the same temperature as the blackbody furnace by the sample heating furnace was measured. Furthermore, the true temperature of the heating furnace was found by coating the surface of the same sample with a blackbody spray (made by Japan Sensor, JSC-3, emission rate 0.94) and heating it by the set temperature for measurement. The ratio of the intensity of the light emitted from the sample to the intensity of light of the emission rate 1 of each wavelength at the true temperature was defined as the emission rate. Further, when the set temperature was 500° C., the true temperature was 500±10° C.

The wavelength dependency of the ordinary temperature emission rate was measured at room temperature. If the average value of the emission rate in the range of the wavelength of 0.5 to 2.0 μm is 0.9 or more, the energy conversion is excellent, so this case is indicated as “Excellent”, if the value is in the range of 0.8 to less than 0.9, the conversion is good, so this case is indicated as “Good”, if the value is in the range of 0.7 to less than 0.8, the conversion may be made practical if improved, so this case is indicated as “Fair”, and if the value is less than 0.7, the utilization for energy conversion is judged difficult, so this case is indicated as “Poor”.

The wavelength dependency of the high temperature emission rate was measured at high temperatures of 500° C. and 600° C. If the average value of the high temperature emission rate in the range of the wavelength 0.5 to 2.0 μm is 0.85 or more, the energy conversion is excellent, so this case is indicated as “Excellent”, if the value is in the range of 0.7 to less than 0.85, the conversion is good, so this case is indicated as “Good”, if the value is in the range of 0.6 to less than 0.7, the conversion can be made practical if improved, so this case is indicated as “Fair”, and if the value is less than 0.6, utilization for energy conversion is judged difficult, so this case is indicated as “Poor”.

The wavelength selectivity of emission was evaluated by the ratio of the ordinary temperature emission rate in the sensitivity region of the wavelength of 0.5 to 2.0 μm with respect to the ordinary temperature emission rate at the long wavelength region of the wavelength of 3 to 5 μm. If the wavelength selectivity is 4 or more, the wavelength selectivity is very good, so this case is indicated as “Excellent”, if the selectivity is in the range of 3 to less than 4, the selectivity is good, so this case is indicated as “Good”, if the selectivity in the range of 2 to less than 3, if improved, the selectivity may be practical, so this case is indicated as “Fair”, and if the selectivity is less than 2, the wavelength selectivity is judged insufficient, so this case is indicated as “Poor”.

The wavelength stability of emission is evaluated by the ratio (M/H) of the lowest value (M) with respect to the highest value (H) of the emission rate in the short wavelength range of the wavelength of 0.5 to 2.0 μm. However, the regions where the emission rate falls at the two ends in the short wavelength range are excluded from coverage. If the ratio of the drop in the emission rate is 0.8 or more, the stability of the wavelength selection is excellent, so this case is indicated as “Excellent”, if the ratio is in the range of 0.7 to less than 0.8, the stability is good, so this case is indicated as “Good”, if the ratio is in the range of 0.5 to less than 0.7, the stability may be practical is improved, so this case is indicated as “Fair”, and if the ratio is less than 0.5, the stability is judged insufficient, so this case is indicated as “Poor”.

The high temperature storability was evaluated by the change in the average value of the ordinary temperature emission rate in the range of the wavelength of 0.5 to 2.0 μm after high temperature heating of the sample in the atmosphere at 700° C. for 200 hours. If the ratio of the ordinary temperature emission rate after high temperature heating to the ordinary temperature emission rate before heating is 0.9 or more, the high temperature storability is excellent, so this case is indicated as “Excellent”, if the ratio is in the range of 0.7 to less than 0.9, the storability is good, so this case is indicated as “Good”, if the ratio is in the range of 0.5 to less than 0.7, use may be possible in a low temperature environment of use, so this case is indicated as “Fair”, and if the ratio is less than 0.5, the high temperature storability is judged insufficient, so this case is indicated as “Poor”.

Table 1 shows thermophotovoltaic conversion members having a multilayer structure of the present embodiment and comparative examples. Samples obtained by forming multilayer structures on silicon substrates with SiC were used.

In each of Examples 1 to 22 relating to a first aspect of the present embodiment, the structure was a multilayer structure comprised of a metal region on which a silicide layer B, dielectric layer M, and silicide layer M are provided in that order, having a thickness of the silicide layer B of 5 nm to 25 nm, having a thickness of the dielectric layer M of 10 nm to 45 nm, and having a thickness of the silicide layer M of 2 nm to 15 nm. The ordinary temperature emission rates were sufficient.

Further, in each of Examples 1 to 6, 8, 9, 11 to 13, 15, 16, and 18 to 21 relating to a fourth aspect, the thickness of the silicide layer B is 60% or less of the thickness of the dielectric layer M contacting it from above. Due to this, it could be confirmed the high temperature emission rates were more excellent. As opposed to this, in each of Comparative Examples 1 to 3, either of the metal region, silicide layer, and dielectric layer was insufficient, while in each of Comparative Examples 4 to 7, either of the silicide layer and dielectric layer was off from the above range of layer thickness relating to the present embodiment. Due to this, it could be confirmed that the high temperature emission rates were inferior.

In each of Examples 4 to 20 and 22 relating to a second aspect, the total number of layers is four to 12 layers, the thickness of the silicide layer B is 5 nm to 25 nm, the thickness of the dielectric layer M is 10 nm to 45 nm, the thickness of the silicide layer M is 2 nm to 15 nm, and the thickness of the dielectric layer T is 80 nm to 200 nm. Due to this, it could be confirmed that the ordinary temperature emission rates and wavelength selectivities were excellent.

In Example 21, the dielectric layer T is off from the above range of layer thickness. Due to this, it could be confirmed that the wavelength selectivity was inferior.

In each of Examples 4 to 7 and 9 to 22 relating to a fifth aspect, the thickness of the dielectric layer T was 8 times or more of the thickness of the silicide layer M. Due to this, it could be confirmed that the wavelength stability was excellent.

In each of Examples 3, 9 to 12, 18, and 20 relating to the third aspect, a dielectric layer B is formed between the metal region and silicide layer B and the thickness of the dielectric layer B is 5 nm to 25 nm. Due to this, it could be confirmed that the high temperature storability was excellent.

In Table 2, the effects of the substrate forming the thermophotovoltaic conversion member of the present embodiment are shown.

In each of Examples 52, 56, and 58 relating to an 11th aspect, as the substrate, silicon or metal formed with an SiC layer on its surface is used. Due to this, it was confirmed that the emission performance at a high temperature of 600° C. was excellent. Further, in Example 54 relating to a 12th aspect, as the substrate, an iron-based material formed with an oxide layer on its surface is used. Due to this, it was confirmed that the emission performance at a high temperature was excellent.

TABLE 1

| | | Multilayer structure (nm) | | | | | | |
|---|---|---|---|---|---|---|---|---|
| | | (Metal | | | | | | |
| | | region side) | Lower layer list from left | | | | | (Surface side) |
| | Metal region | Dielectric layer | Silicide layer | Dielectric layer | Silicide layer | Dielectric layer | Silicide layer | Dielectric layer |
| Ex. 1 | Au 60 | | β-FeSi₂ 8 | SiO₂ 30 | β-FeSi₂ 10 | | | |
| Ex. 2 | W 350 | | β-FeSi₂ 15 | SiO₂ 40 | CrSi₂ 15 | | | |
| Ex. 3 | Mo 150 | SiO₂ 10 | β-FeSi₂ 5 | SiO₂ 30 | β-FeSi₂ 10 | | | |
| Ex. 4 | Ni 400 | | β-FeSi₂ 5 | SiO₂ 20 | β-FeSi₂ 2 | SiO₂ 80 | | |
| Ex. 5 | Fe 200 | | β-FeSi₂ 20 | SiO₂ 40 | β-FeSi₂ 10 | SiO₂ 140 | | |
| Ex. 6 | Cr 80 | | CrSi₂ 15 | SiO₂ 30 | CrSi₂ 10 | SiO₂ 200 | | |
| Ex. 7 | W 80 | | β-FeSi₂ 25 | SiO₂ 35 | β-FeSi₂ 15 | Al₂O₃ 130 | | |
| Ex. 8 | SUS 250 | | β-FeSi₂ 20 | SiO₂ 35 | β-FeSi₂ 13 | SiO₂ 82 | | |
| Ex. 9 | Mo 70 | SiO₂ 5 | β-FeSi₂ 17 | SiO₂ 30 | β-FeSi₂ 5 | SiO₂ 190 | | |
| Ex. 10 | SUS 100 | | β-FeSi₂ 20 | Al₂O₃ 27 | CrSi₂ 10 | Al₂O₃ 120 | | |
| Ex. 11 | Cr 200 | SiO₂ 13 | β-FeSi₂ 20 | SiO₂ 40 | β-FeSi₂ 10 | Al₂O₃ 100 | | |
| Ex. 12 | Au 100 | SiO₂ 109 | CrSi₂ 18 | Al₂O₃ 45 | β-FeSi₂ 12 | SiO₂ 120 | β-FeSi₂ 10 | |
| Ex. 13 | W 100 | | β-FeSi₂ 5 | SiO₂ 10 | β-FeSi₂ 5 | SiO₂ 100 | β-FeSi₂ 4 | |
| Ex. 14 | W 200 | | β-FeSi₂ 20 | SiO₂ 22 | β-FeSi₂ 10 | SiO₂ 80 | β-FeSi₂ 5 | |
| Ex. 15 | Mo 80 | | β-FeSi₂ 23 | SiO₂ 40 | β-FeSi₂ 12 | SiO₂ 20 | β-FeSi₂ 8 | SiO₂ 80 |
| Ex. 16 | W 250 | | CrSi₂ 15 | SiO₂ 40 | β-FeSi₂ 8 | SiO₂ 38 | β-FeSi₂ 13 | SiO₂ 113 |
| Ex. 17 | SUS 20 | | CrSi₂ 20 | Al₂O₃ 30 | β-FeSi₂ 10 | Al₂O₃ 30 | β-FeSi₂ 10 | Al₂O₃ 90 |
| Ex. 18 | W 150 | SiO₂ 10 | β-FeSi₂ 20 | SiO₂ 40 | β-FeSi₂ 7 | Al₂O₃ 30 | β-FeSi₂ 13 | SiO₂ 190 |
| Ex. 19 | W 150 | | β-FeSi₂ 20/SiO₂ 35/β-FeSi₂ 8/SiO₂ 44/β-FeSi₂ 12/ | | | | | |
| | | | SiO₂ 90/β-FeSi₂ 8/SiO₂ 120 | | | | | |
| Ex. 20 | W 150 | SiO₂ 10 | β-FeSi₂ 15/SiO₂ 30/β-FeSi₂ 8/SiO₂ 30/β-FeSi₂ 10/ | | | | | |
| | | | SiO₂ 36/β-FeSi₂ 8/SiO₂ 38/β-FeSi₂ 10/SiO₂ 120 | | | | | |
| Ex. 21 | W 100 | | β-FeSi₂ 5 | SiO₂ 12 | β-FeSi₂ 6 | SiO₂ 74 | β-FeSi₂ 23 | |
| Ex. 22 | Cu 100 | | β-FeSi₂ 17 | SiO₂ 16 | β-FeSi₂ 15 | SiO₂ 220 | β-FeSi₂ 10 | SiO₂ 170 |
| Comp. Ex. 1 | SUS 200 | | β-FeSi₂ 5 | | | | | |
| Comp. Ex. 2 | Mo 100 | | β-FeSi₂ 5 | SiO₂ 40 | | | | |
| Comp. Ex. 3 | | | β-FeSi₂ 3 | SiO₂ 6 | β-FeSi₂ 8 | SiO₂ 110 | | |
| Comp. Ex. 4 | Cr 100 | | β-FeSi₂ 17 | SiO₂ 39 | β-FeSi₂ 1 | SiO₂ 95 | | |
| Comp. Ex. 5 | W 130 | | β-FeSi₂ 27 | SiO₂ 27 | β-FeSi₂ 10 | SiO₂ 140 | | |
| Comp. Ex. 6 | Cu 100 | SiO₂ 10 | β-FeSi₂ 27 | SiO₂ 50 | CrSi₂ 18 | SiO₂ 110 | | |
| Comp. Ex. 7 | SUS 100 | | | SiO₂ 10 | β-FeSi₂ 22 | SiO₂ 110 | β-FeSi₂ 9 | SiO₂ 210 |

| | Ordinary | | | | |
|---|---|---|---|---|---|
| | temp. | High temp. | Wavelength | Wavelength | |
| | emission | emission | selectivity | stability of | High temp. |
| | rate | rate (500° C.) | of emission | emission | storability |
| Ex. 1 | Good | Excellent | Good | Good | Good |
| Ex. 2 | Good | Excellent | Good | Good | Good |
| Ex. 3 | Good | Excellent | Good | Good | Excellent |
| Ex. 4 | Excellent | Excellent | Excellent | Excellent | Good |
| Ex. 5 | Excellent | Excellent | Excellent | Excellent | Good |
| Ex. 6 | Excellent | Excellent | Excellent | Excellent | Good |
| Ex. 7 | Excellent | Good | Excellent | Excellent | Good |
| Ex. 8 | Excellent | Excellent | Excellent | Good | Good |
| Ex. 9 | Excellent | Excellent | Excellent | Excellent | Excellent |
| Ex. 10 | Excellent | Good | Excellent | Excellent | Excellent |
| Ex. 11 | Excellent | Excellent | Excellent | Excellent | Excellent |
| Ex. 12 | Excellent | Excellent | Excellent | Excellent | Excellent |
| Ex. 13 | Excellent | Excellent | Excellent | Excellent | Good |
| Ex. 14 | Excellent | Good | Excellent | Excellent | Good |
| Ex. 15 | Excellent | Excellent | Excellent | Excellent | Good |
| Ex. 16 | Excellent | Excellent | Excellent | Excellent | Good |
| Ex. 17 | Excellent | Good | Excellent | Excellent | Good |
| Ex. 18 | Excellent | Excellent | Excellent | Excellent | Excellent |
| Ex. 19 | Excellent | Excellent | Excellent | Excellent | Good |
| Ex. 20 | Excellent | Excellent | Excellent | Excellent | Excellent |
| Ex. 21 | Excellent | Excellent | Good | Excellent | Good |
| Ex. 22 | Excellent | Good | Excellent | Excellent | Good |
| Comp. Ex. 1 | Poor | Poor | Poor | Fair | Fair |
| Comp. Ex. 2 | Poor | Poor | Poor | Poor | Fair |
| Comp. Ex. 3 | Fair | Fair | Poor | Poor | Fair |
| Comp. Ex. 4 | Fair | Fair | Poor | Poor | Good |
| Comp. Ex. 5 | Fair | Fair | Poor | Poor | Good |
| Comp. Ex. 6 | Fair | Fair | Poor | Poor | Fair |
| Comp. Ex. 7 | Fair | Fair | Poor | Poor | Fair |

TABLE 2

| | | Multilayer structure (nm) | | | | | | |
|---|---|---|---|---|---|---|---|---|
| | | (Metal region side) | | | | | | |
| | | (Metal | | | | | High temp. | Wavelength |
| | | region side) | Lower layer arranged from left | | (Surface side) | | emission | selectivity |
| | Metal region | Silicide layer | Dielectric layer | Silicide layer | Dielectric layer | Substrate | rate (600° C.) | of emission |
| Ex. 51 | W 100 | β-FeSi₂ 13 | SiO₂ 30 | β-FeSi₂ 10 | | Si | Good | Good |
| Ex. 52 | W 100 | β-FeSi₂ 13 | SiO₂ 30 | β-FeSi₂ 10 | | Si with SiC film 5 μm | Excellent | Excellent |
| Ex. 53 | W 100 | β-FeSi₂ 13 | SiO₂ 30 | β-FeSi₂ 10 | | Fe | Good | Good |
| Ex. 54 | W 100 | β-FeSi₂ 13 | SiO₂ 30 | β-FeSi₂ 10 | | Fe with oxide film 5 μm | Excellent | Excellent |
| Ex. 55 | W 100 | β-FeSi₂ 20 | SiO₂ 40 | β-FeSi₂ 10 | SiO₂ 100 | Si | Good | Good |
| Ex. 56 | W 100 | β-FeSi₂ 20 | SiO₂ 40 | β-FeSi₂ 10 | SiO₂ 100 | Si with SiC film 10 μm | Excellent | Excellent |
| Ex. 57 | Mo 100 | β-FeSi₂ 20 | SiO₂ 40 | β-FeSi₂ 10 | SiO₂ 100 | Mo | Good | Good |
| Ex. 58 | Mo 100 | β-FeSi₂ 20 | SiO₂ 40 | β-FeSi₂ 10 | SiO₂ 100 | Mo with SiC film 5 μm | Excellent | Excellent |

Modification

The present invention is not limited to the above embodiments and can be suitably changed in the range of the gist of the present invention.

### REFERENCE SIGNS LIST

1. metal region
2. silicide layer B at bottommost part
3. dielectric layer M at middle
4. silicide layer M at middle
5. dielectric layer T closest to surface
6. dielectric layer B at bottommost part
7. sensitivity region (range of wavelength of 0.5 to 2.0 μm)
8. long wavelength region (range of wavelength of 3 to 5 μm)

1. A thermophotovoltaic conversion member comprised of a multilayer structure comprised of a metal region on which at least one silicide layer and dielectric layer are alternately formed, a total number of said silicide layers and said dielectric layers being three layers to 12 layers,
said multilayer structure having, in order on said metal region, a silicide layer B positioned most at said metal region side among said silicide layers, a dielectric layer M among said dielectric layers, and a silicide layer M other than said silicide layer B among said silicide layers and
said silicide layer B having a thickness of 5 nm to 25 nm, said dielectric layer M having a thickness of 10 nm to 45 nm, and said silicide layer M having a thickness of 2 nm to 15 nm.

2. The thermophotovoltaic conversion member according to claim 1, wherein a dielectric layer T among said dielectric layers is further formed at a surfacemost side, the total of the number of said silicide layers and said dielectric layers is four layers to 12 layers, and said dielectric layer T has a thickness of 80 nm to 200 nm.

3. The thermophotovoltaic conversion member according to claim 1, wherein said metal region and said silicide layer B further have a dielectric layer B among said dielectric layers formed between them and said dielectric layer B has a thickness of 5 nm to 25 nm.

4. The thermophotovoltaic conversion member according to claim 1 wherein said silicide layer B has a thickness of 60% or less of the thickness of said dielectric layer M contacting said silicide layer B from above.

5. The thermophotovoltaic conversion member according to claim 2, wherein said dielectric layer T has a thickness of 8 times or more the thickness of said silicide layer M contacting said dielectric layer T from below.

6. The thermophotovoltaic conversion member according to claim 1 wherein said multilayer structure has said dielectric layer at its surface.

7. The thermophotovoltaic conversion member according to claim 1 wherein said silicide layer is mainly comprised of β-FeSi₂ or CrSi₂.

8. The thermophotovoltaic conversion member according to claim 1 wherein said dielectric layer is mainly comprised of SiO₂ or Al₂O₃.

9. The thermophotovoltaic conversion member according to claim 1 wherein said metal region is mainly comprised of one metal selected from a W, Mo, Fe, Ni, Cr, Au, Ag, and Fe alloy.

10. The thermophotovoltaic conversion member according to claim 1 wherein said metal region has a thickness of 20 nm or more.

11. The thermophotovoltaic conversion member according to claim 1 wherein a substrate is formed below said metal region, said substrate is comprised of silicon or metal, and an SiC layer is formed at the surface side of said substrate.

12. The thermophotovoltaic conversion member according to claim 1 wherein a substrate is formed below said metal region, said substrate is comprised of at least one of Fe, an Fe alloy, and an Ni alloy, and an oxide layer is formed at a surface side of said substrate.
